(19) United States
(12) Patent Application Publication
(10) Pub. No.: US 2026/0018833 A1
(43) Pub. Date: Jan. 15, 2026

(54) SHIELD BRACKET AND WIRE HARNESS

(71) Applicant: Yazaki Corporation, Tokyo (JP)

(72) Inventors: Yuto ITO, Tochigi (JP); Koji YAMAZAKI, Tochigi (JP); Jumpei KATO, Tochigi (JP); Go TATEMICHI, Tochigi (JP); Keisuke KITAJO, Tochigi (JP)

(73) Assignee: Yazaki Corporation, Tokyo (JP)

(21) Appl. No.: 19/230,498

(22) Filed: Jun. 6, 2025

(30) Foreign Application Priority Data
Jul. 10, 2024 (JP) 2024-110739

(51) Int. Cl. H01R 13/6582; H01B 7/00; H01R 13/24; H01R 13/6596

(52) U.S. Cl. CPC H01R 13/6582; H01B 7/0045; H01R 13/2407; H01R 13/2457; H01R 13/6596

(57) ABSTRACT

A shield bracket includes a shield bracket body that is formed in a tubular shape so that an electric wire is inserted in the shield bracket body, and a braided member covering the electric wire is disposed on an outer periphery of the shield bracket body, and the shield bracket body is electrically connected to the braided member; and a fixing member that is fixed to an object to be fixed and is provided to be attachable to the shield bracket body. The wire harness includes the electric wire, the braided member covering the electric wire, and the shield bracket.

### CROSS-REFERENCE TO RELATED APPLICATION(S)

The present application claims priority to and incorporates by reference the entire contents of Japanese Patent Application No. 2024-110739 filed in Japan on Jul. 10, 2024.

### BACKGROUND OF THE INVENTION

### 1. Field of the Invention

The present invention relates to a shield bracket and a wire harness.

### 2. Description of the Related Art

As a technique relating to a conventional shield bracket and wire harness, for example, JP 2022-124868 A discloses a wire harness that includes: a plurality of electric wires connected to a plurality of terminals; a resin housing including a hood portion with an opening for exposing the plurality of terminals to the inside, and a holding portion for holding the plurality of terminals and the plurality of electric wires; a metallic shield shell that covers the holding portion and is fixed to a case of a device; and a metallic bracket that covers the holding portion and is attached to the shield shell. The shield shell is provided with two fixing portions for fixing the shield shell to an object to be fixed.

Meanwhile, in the shield bracket including such a shield shell and a bracket, for example, the two fixing portions of the shield bracket are sometimes fixed to an object to be fixed by screw fastening. The shield bracket could be further improved in terms of the configuration for fixing the shield bracket to the object to be fixed.

### SUMMARY OF THE INVENTION

The present invention has been made in view of the above circumstances, and an object of the present invention is to provide a shield bracket and a wire harness capable of appropriately achieving the fixing of the shield bracket to an object to be fixed.

In order to achieve the above mentioned object, a shield bracket according to one aspect of the present invention includes a shield bracket body that is formed in a tubular shape so that an electric wire is inserted in the shield bracket body, and a braided member disposed on an outer periphery of the shield bracket body to cover the electric wire, and the shield bracket body is electrically connected to the braided member; and a fixing member that is fixed to an object to be fixed and is provided to be attachable to the shield bracket body.

In order to achieve the above mentioned object, a wire harness according to another aspect of the present invention includes an electric wire; a braided member that covers the electric wire; and a shield bracket that includes a shield bracket body that is formed in a tubular shape so that an electric wire is inserted in the shield bracket body, and the braided member disposed on an outer periphery of the shield bracket body, and the shield bracket body is electrically connected to the braided member, and a fixing member that is fixed to an object to be fixed and is provided to be attachable to the shield bracket body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wire harness including a shield bracket according to a first embodiment;

FIG. 2 is an exploded perspective view illustrating a state in which a shield bracket body including a holder fixed to an electric wire is removed from a fixing member according to the first embodiment;

FIG. 3 is an exploded perspective view illustrating a shield bracket body and the holder according to the first embodiment;

FIG. 4 is a cross-sectional view taken along line IV-IV of FIG. 2;

FIG. 5 is an exploded perspective view illustrating the fixing member according to an embodiment;

FIG. 6 is a cross-sectional view taken along line VI-VI of FIG. 1;

FIG. 7 is a cross-sectional view taken along line VII-VII of FIG. 6;

FIG. 8 is a cross-sectional view taken along line VIII-VIII of FIG. 6;

FIG. 9 is a perspective view illustrating a wire harness including a shield bracket according to a second embodiment;

FIG. 10 is an exploded perspective view illustrating a state in which a shield bracket body including a holder fixed to an electric wire is removed from a fixing member according to the second embodiment;

FIG. 11 is a perspective view illustrating a contact member according to the second embodiment;

FIG. 12 is a cross-sectional view taken along line XII-XII of FIG. 9;

FIG. 13 is a perspective view illustrating a wire harness including a shield bracket according to a modification to the second embodiment; and

FIG. 14 is an exploded perspective view illustrating a state in which a shield bracket body including a holder fixed to an electric wire is removed from a fixing member according to the modification to the second embodiment.

### DETAILED DESCRIPTION OF THE PREFERRED EMBODIMENTS

Hereinafter, embodiments according to the present invention will be described in detail with reference to the drawings. Note that the present invention is not limited to the embodiments. In addition, constituent elements in the following embodiments include those that can be easily replaced by those skilled in the art or those that are substantially the same.

### First Embodiment

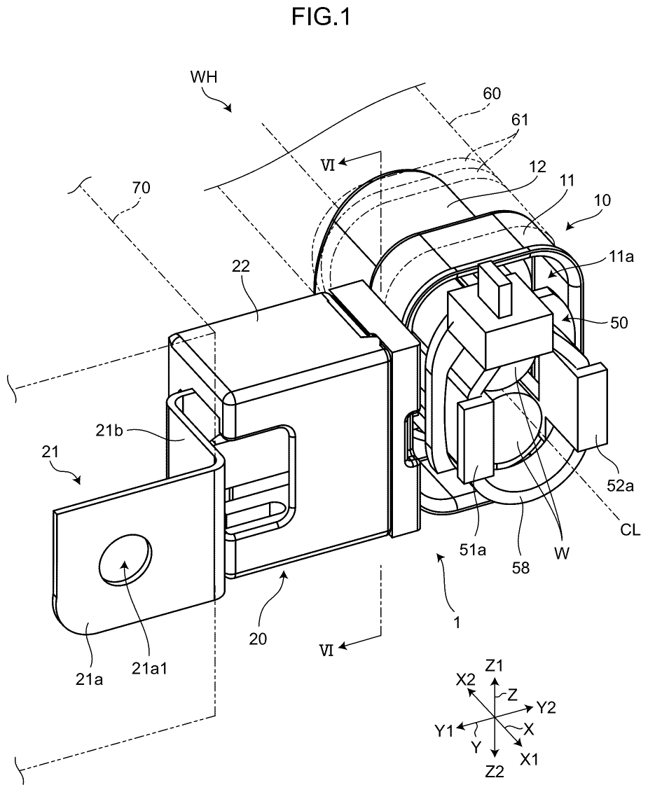

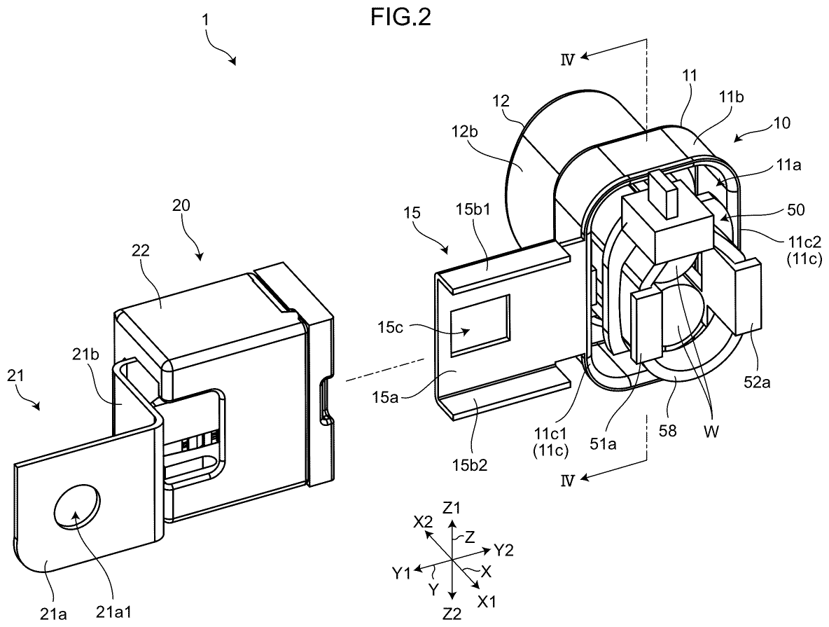

A wire harness WH of the present embodiment illustrated in FIGS. 1 and 2 is configured such that a plurality of electric wires W used for signal communication is bundled to form a collective component, and the plurality of electric wires W is connected to devices mounted in a vehicle by a connector or the like for connection between the devices. The wire harness WH of the present embodiment includes two electric wires W, a braided member 60 covering the two electric wires W, and a shield bracket 1 which is electrically connected to the braided member 60 and into which the two electric wires W are inserted. In the drawings, only a part of the electric wires W is illustrated, and the internal structure is omitted. The shield bracket 1 includes a shield bracket body 10, a fixing member 20, and a holder 50. The braided member 60 covering the two electric wires W is disposed around the outer periphery of the shield bracket body 10. The fixing member 20 is fixed to an object to be fixed 70, and is provided to allow the shield bracket body 10 to be attached and detached (namely, to be attachable).

In the following description, a direction in which the electric wire W extends is referred to as an axial direction X, and two directions orthogonal to the axial direction X are referred to as a width direction Y and a height direction Z. The description will be given assuming that one side in the axial direction X is referred to as one side X1, and another side in the axial direction X is referred to as the other side X2. Similarly, the description will be given assuming that the width direction Y has one side Y1 and the other side Y2, and the height direction Z has one side Z1 and the other side Z2.

As illustrated in FIGS. 1 to 4, the shield bracket body 10 is formed in a substantially cylindrical shape with an axis CL (see FIG. 1) as a direction along the axial direction X. The shield bracket body 10 is formed of, for example, a conductive metal material such as aluminum or an aluminum alloy. The shield bracket body 10 includes a rectangular tube portion 11 on one side X1 in the axial direction X and an elongated cylindrical portion 12 connected to the rectangular tube portion 11 on the other side X2 in the axial direction X. The rectangular tube portion 11 has an opening 11a that is open on one side X1 in the axial direction X, and the elongated cylindrical portion 12 has an opening 12a that is open on the other side X2. The rectangular tube portion 11 is formed in a substantially rectangular tube shape in which an outer peripheral wall 11b formed around the axial direction X is long in the height direction Z, and the rectangular tube portion 11 has corners formed in an R shape. The elongated cylindrical portion 12 is formed in an elliptical cylindrical shape in which an outer peripheral wall 12b is formed around the axial direction X and has a long axis along the height direction Z. The elongated cylindrical portion 12 is connected to a bottom plate 13 formed on the other side X2 in the axial direction X of the rectangular tube portion 11. The rectangular tube portion 11 and the elongated cylindrical portion 12 communicate with each other with their axes aligned, and are integrally formed.

The rectangular tube portion 11 of the shield bracket body 10 is provided with a body-side conductive portion 15. The body-side conductive portion 15 extends along one side Y1 in the width direction Y from an edge 11c1 on one side Y1 in the width direction Y. The edge 11c1 is one of two edges 11cl and 11c2 which form a part of an edge 11c of the opening 11a in the rectangular tube portion 11 of the shield bracket body 10 and are along the height direction Z. The body-side conductive portion 15 is formed in a substantially plate shape with the plate surface facing the axial direction X. The body-side conductive portion 15 includes a plate-like body-side contact plate 15a (contact portion) connected to the edge 11c1 of the rectangular tube portion 11 with the plate surface facing the axial direction X, and two bent portions 15b1 and 15b2. The two bent portions 15b1 and 15b2 are formed by bending the body-side contact plate 15a from ends on one side Z1 and the other side 22 in the height direction Z toward one side X1 in the axial direction X. The bent portion 15b1 is provided at the end of the body-side contact plate 15a on one side Z1 in the height direction Z, and the bent portion 15b2 is provided at the end thereof on the other side Z2 in the height direction Z. The bent portions 15b1 and 15b2 are formed to extend in the width direction Y which is the longitudinal direction of the body-side contact plate 15a. Further, the body-side contact plate 15a of the body-side conductive portion 15 is provided with a locked opening 15c (locked portion) that is open along the axial direction X. The locked opening 15c has a substantially rectangular shape whose longitudinal direction is the width direction Y.

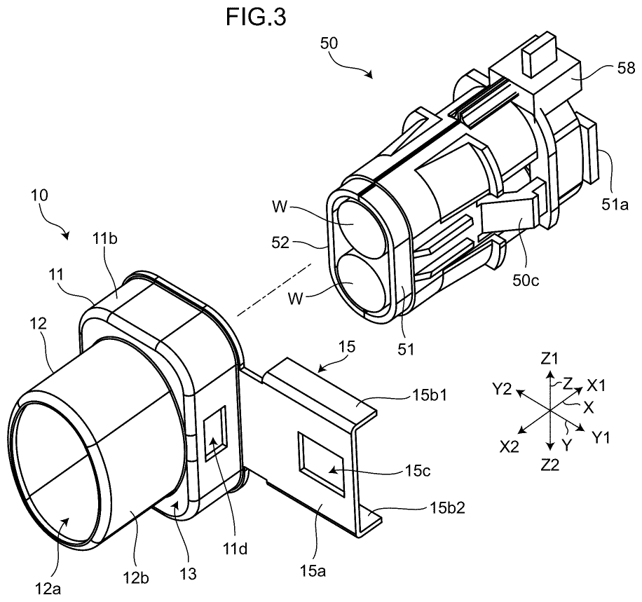

Further, the outer peripheral wall 11b of the rectangular tube portion 11 in the shield bracket body 10 is provided with two holder locked openings 11d (see FIG. 3). The two holder locked openings 11d are provided: one on the outer peripheral wall 11b on one side Y1 in the width direction Y, and one on the outer peripheral wall 11b (not illustrated) on the other side Y2 in the width direction Y.

The holder 50 can be made of a resin material, has an axis along the axial direction X, and is formed in a substantially cylindrical shape in which the inner surface has a substantially rectangular shape with rounded corners whose longitudinal direction is the height direction Z. The holder 50 is formed by combining a first holder 51 on one side Y1 and a second holder 52 on the other side Y2 in the width direction Y. Inside the holder 50, the two electric wires W disposed along the height direction Z are provided.

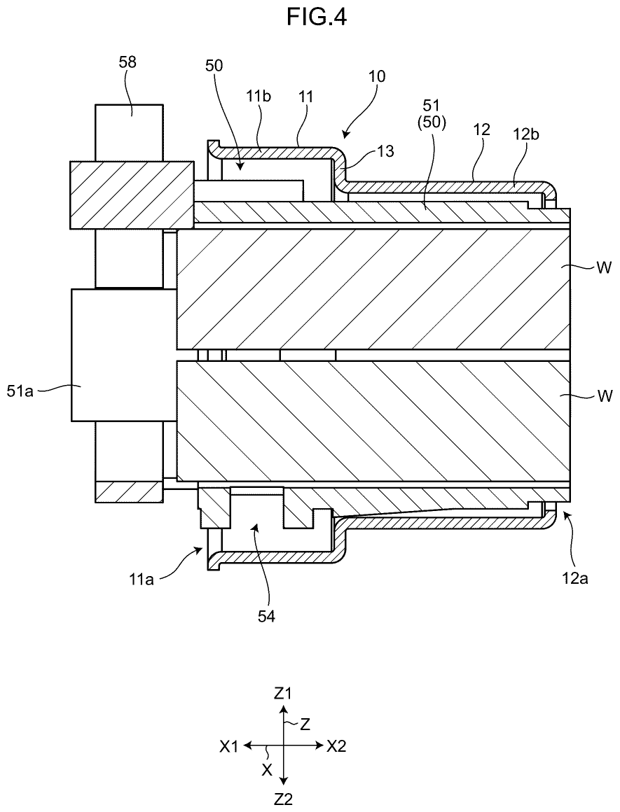

On one side X1 in the axial direction X of the first holder 51 and the second holder 52, band locking portions 51a and 52a extending in a beam shape toward one side X1 are provided, respectively. Here, although details are not illustrated, the first holder 51 and the second holder 52 are provided with a locking portion 54 (see FIG. 4) in a form in which a hook-shaped locking protrusion is caught on a locking hole on the other side 22 in the height direction Z. In the holder 50, the first holder 51 and the second holder 52 are engaged and combined with each other by the locking portion 54. Then, the band locking portions 51a and 52a are wound around and tightened by a cable tie 58. When the cable tie 58 tightens, the first holder 51 and the second holder 52 clamp the two electric wires W disposed therein. In this manner, the holder 50 is fixed to the two electric wires W disposed inside the holder 50.

A leaf spring-like locking protrusion 50c is provided on one side Y1 in the width direction Y of the first holder 51. The locking protrusion 50c is engaged with the holder locked opening 11d on one side Y1 in the width direction Y of the rectangular tube portion 11 of the shield bracket body 10. Similarly, the second holder 52 is also provided with a leaf spring-like locking protrusion 50c (not illustrated), and the locking protrusion 50c is engaged with the holder locked opening 11d (not illustrated) on the other side Y2 in the width direction Y of the rectangular tube portion 11 of the shield bracket body 10.

In order to attach the shield bracket body 10 to the electric wire W, first, ends of the two electric wires W are passed through the opening 12a of the elongated cylindrical portion 12 in the shield bracket body 10. That is, the opening 11a of the rectangular tube portion 11 in the shield bracket body 10 is located on the end side of the two electric wires W. At this time, the braided member 60 covering the two electric wires W is folded back or the like to be peeled off from the electric wires W passed through the shield bracket body 10. Thereafter, the holder 50 is fixed to the two electric wires W on the opening 11a side of the shield bracket body 10. Then, the shield bracket body 10 is moved toward the holder 50 to engage the locking protrusions 50c of the holder 50 with the holder locked openings 11d of the shield bracket body 10. This allows the holder 50 fixed to the two electric wires W to be fixed to the shield bracket body 10. Therefore, the shield bracket body 10 is fixed to the two electric wires W via the holder 50. In this manner, the two electric wires W are inserted into the shield bracket body 10. In other words, the shield bracket body 10 is formed in a substantially cylindrical shape such that the two electric wires W are inserted thereinto.

The braided member 60 is disposed on the outer periphery of the shield bracket body 10. The braided member 60 is formed by interweaving a braided wire made of a conductive metal material such as copper or aluminum, and blocks electromagnetic waves. The braided member 60 is attached to the shield bracket body 10 so as to cover the end of the braided member 60 from the other side X2 toward one side X1 in the axial direction X of the shield bracket body 10. For example, the braided member 60 is attached to the outer periphery of the shield bracket body 10 by caulking a metallic shield ring 61. The braided member 60 includes a part in close contact with the shield bracket body 10. Therefore, the braided member 60 is electrically connected to the shield bracket body 10.

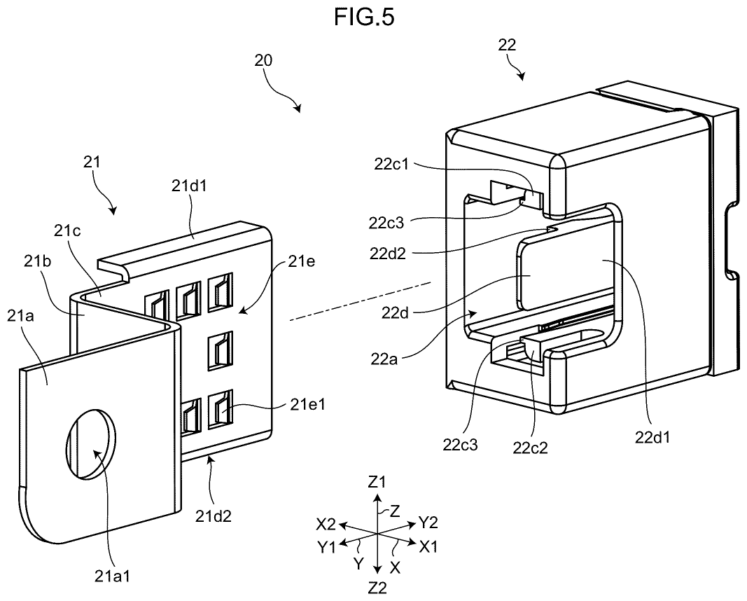

As illustrated in FIGS. 5 to 8, the fixing member 20 includes a fixing-side conductive portion 21 and an attachment member 22. The fixing-side conductive portion 21 is formed in a substantially crank shape by using a sheet metal material having electrical conductivity, and is disposed such that the plate surface faces the axial direction X. In the fixing-side conductive portion 21, a fixing plate 21a (fixing portion) is provided on one side Y1 in the width direction Y, a contact plate 21c is provided on the other side Y2 in the width direction Y, and the fixing plate 21a and the contact plate 21c are connected by a connection plate 21b extending from an end of the contact plate 21c on one side Y1 to one side X1 in the axial direction X. The fixing plate 21a is provided with a circular fixing hole 21a1 that is open along the axial direction X.

The fixing-side conductive portion 21 is fixed to the attachment member 22. Specifically, the contact plate 21c of the fixing-side conductive portion 21 is inserted into the attachment member 22 and, thus, the contact plate 21c is fixed to the attachment member 22. The fixing member 20 is fixed to the object to be fixed 70 by inserting a bolt or the like (not illustrated) into the fixing hole 21a1 and fastening it to the object to be fixed 70. Bent portions 21d1 and 21d2 are formed at ends of the contact plate 21c on one side Z1 and the other side 22 in the height direction Z. The bent portions 21d1 and 21d2 are formed along the width direction Y by bending toward the other side X2 in the axial direction X. The bent portion 21d1 is provided on one side Z1 in the height direction Z, and the bent portion 21d2 is provided on the other side Z2. The contact plate 21c is provided with a spring contact portion 21e including a plurality of spring contacts 21e1.

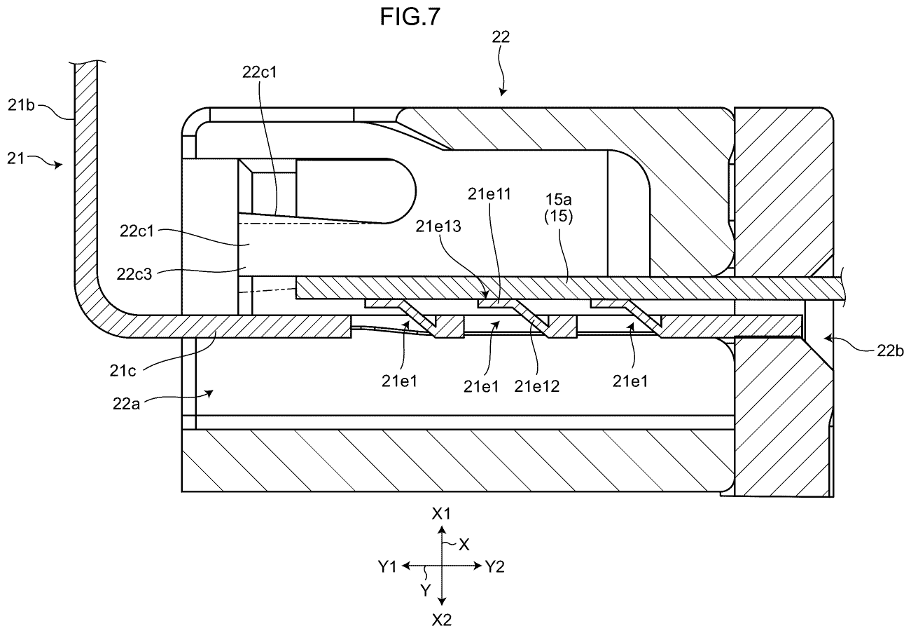

As illustrated in FIGS. 5 and 7, the spring contact 21e1 includes a touch plate 21e11 and a leaf spring portion 21e12. The touch plate 21e11 is provided substantially parallel to the contact plate 21c and protrudes to one side X1 in the axial direction X. The leaf spring portion 21e12 is connected to the contact plate 21c and supports the touch plate 21e11 so that an elastic force is applied thereto. A surface of the touch plate 21e11 on one side X1 in the axial direction X is a touch surface 21e13.

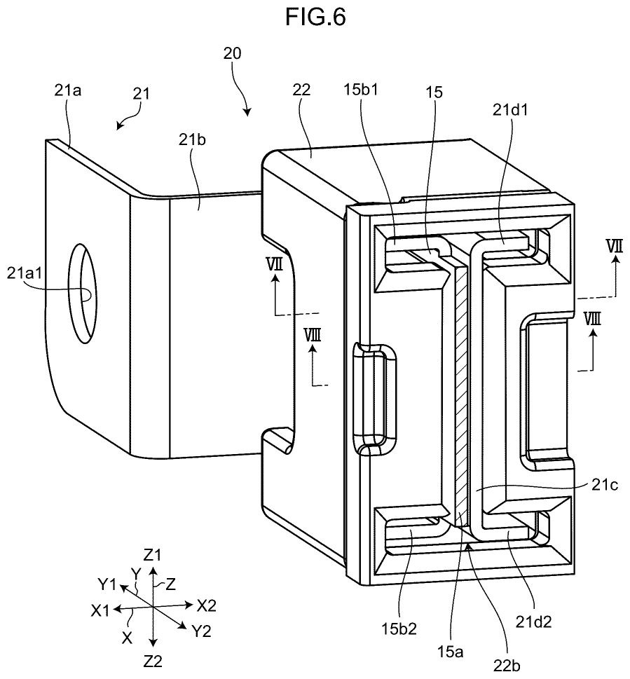

As illustrated in FIGS. 5 to 8, the attachment member 22 is formed in a substantially rectangular parallelepiped shape slightly longer in the width direction Y. The attachment member 22 is made of a resin material. In the attachment member 22, an internal space is formed so as to penetrate in the width direction Y, an attachment opening 22a is provided on one side Y1, and an insertion port 22b is provided on the other side Y2. The attachment opening 22a is open in a substantially rectangular shape, which is long in the height direction Z, in which parts corresponding to guide portions 22c1 and 22c2 to be described later are wide. As illustrated in FIG. 6, the insertion port 22b is open in a substantially H shape. The body-side conductive portion 15 is so inserted that it is located on one side X1 in the axial direction X with respect to the contact plate 21c such that the bent portions 15b1 and 15b2 of the body-side conductive portion 15 and the bent portions 21d1 and 21d2 of the fixing-side conductive portion 21 are in opposite directions in the axial direction X.

As illustrated in FIG. 5, the two guide portions 22c1 and 22c2 formed along the width direction Y are provided in the internal space of the attachment member 22. The guide portion 22c1 is provided on one side Z1 in the height direction Z, and the guide portion 22c2 is provided on the other side Z2. The guide portions 22c1 and 22c2 guide the body-side conductive portion 15 of the shield bracket body 10 to be inserted into the attachment member 22. The guide portions 22c1 and 22c2 each include a sliding contact portion 22c3 that is formed to have a small width (distance in the height direction Z) and provided to be elongated in the width direction Y. The sliding contact portion 22c3 is in sliding contact with a surface on one side X1 in the axial direction X of the body-side contact plate 15a of the body-side conductive portion 15 of the shield bracket body 10. As illustrated in FIG. 7, the guide portions 22c1 and 22c2 are formed in a beam shape on one side Y1 in the width direction Y. When the body-side conductive portion 15 is inserted into the attachment member 22, the guide portions 22c1 and 22c2 are deformed toward one side X1 in the axial direction X from the state indicated by the two-dot chain line in FIG. 7, and bias the inserted body-side conductive portion 15 toward the other side X2 in the axial direction X, that is, toward the contact plate 21c. On the other hand, an elastic force is applied to the touch surface 21e13 of each of the spring contacts 21e1 of the contact plate 21c by the leaf spring portion 21e12. Therefore, the touch surface 21e13 of each of the spring contacts 21e1 is in close contact with the surface on the other side X2 of the body-side contact plate 15a of the body-side conductive portion 15 inserted into the attachment member 22. As a result, the fixing-side conductive portion 21 and the body-side conductive portion 15 are electrically connected and conducted.

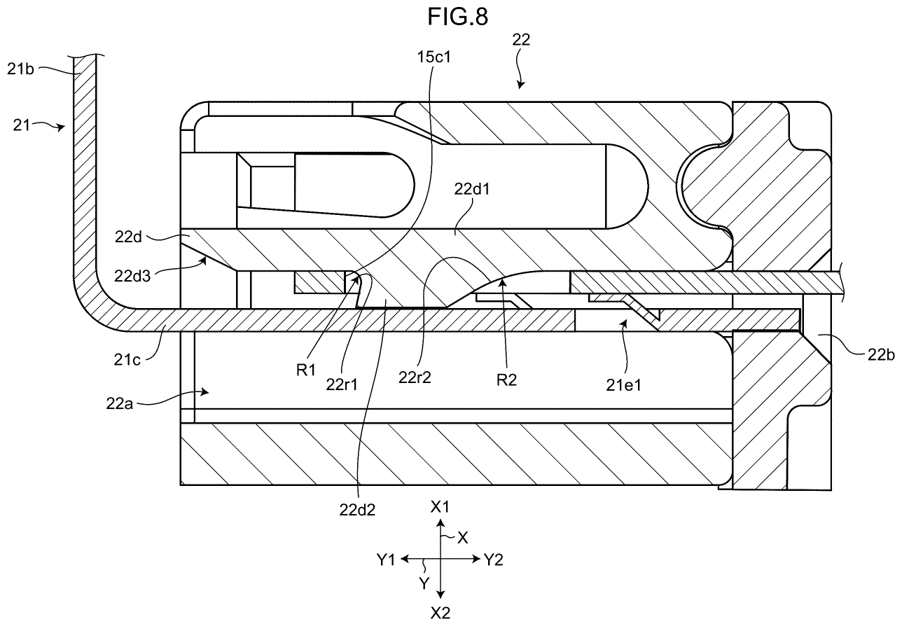

Further, as illustrated in FIG. 5, a locking portion 22d is provided between the guide portions 22c1 and 22c2 in the internal space of the attachment member 22. The locking portion 22d is formed in a tongue shape extending to one side Y1 in the width direction Y, and can be deformed in the axial direction X with an end on one side Y1 as a free end and an end on the other side Y2 as a fixed end. As illustrated in FIG. 8, the locking portion 22d includes a plate-like body portion 22d1 having a flat plate shape and a locking protrusion 22d2 protruding from the plate-like body portion 22d1 to the other side X2 in the axial direction X. The locking protrusion 22d2 is connected to the plate-like body portion 22d1 via a first connection portion 22r1 having a radius of curvature R1 on one side Y1 in the width direction Y, and is connected to the plate-like body portion 22d1 at a second connection portion 22r2 having a radius of curvature R2 on the other side Y2. The surface of the locking protrusion 22d2 on the other side X2 in the axial direction X is flat.

The radius of curvature R1 of the first connection portion 22r1 is formed to be sufficiently smaller than the radius of curvature R2 of the second connection portion 22r2. Therefore, when the body-side conductive portion 15 is moved toward one side Y1 in the width direction Y to be inserted into the attachment member 22, the distal end of the body-side conductive portion 15 comes into sliding contact with the second connection portion 22r2 to deform the locking portion 22d to one side X1 in the axial direction X. Thereafter, due to a restoring force of the locking portion 22d, the locking protrusion 22d2 is fitted into the locked opening 15c, and the locking protrusion 22d2 is engaged with the locked opening 15c. On the other hand, when the body-side conductive portion 15 is moved in a direction along which the body-side conductive portion 15 is to be pulled out (the other side Y2 in the width direction Y), an edge 15c1 of the locked opening 15c on one side Y1 in the width direction Y abuts on the first connection portion 22r1 and the surface on one side Y1 of the locking protrusion 22d2 connected to the first connection portion 22r1, which prevents the body-side conductive portion 15 from being easily pulled out. Note that the locking portion 22d has a tapered surface 22d3 that rises from the tip of the locking portion 22d toward the side of the locking protrusion 22d2. When a hook-shaped tool or the like is hooked on the tapered surface 22d3 and the locking portion 22d is pulled up to one side X1 in the axial direction X, the locked opening 15c is disengaged from the locking protrusion 22d2. The tapered surface 22d3 allows the hook-shaped tool or the like to be smoothly inserted into and hooked on the locking portion 22d. When the locked opening 15c is disengaged from the locking protrusion 22d2, the body-side conductive portion 15 is pulled out from the attachment member 22, and the shield bracket body 10 can be easily detached from the fixing member 20.

In this manner, the shield bracket body 10 is fixed to the object to be fixed 70 via the fixing member 20. The shield bracket body 10 is attachable to and detachable from the fixing member 20 along the width direction Y. The shield bracket body 10 can be attached to the electric wire W provided with the braided member 60 in a state where the shield bracket body 10 is detached from the fixing member 20. Then, after completion of work of assembling the electric wire W and the braided member 60 into the shield bracket body 10, the body-side conductive portion 15 of the shield bracket body 10 is inserted into the attachment member 22 of the fixing member 20, so that the shield bracket body 10 is attached to the fixing member 20. Thus, the braided member 60 is electrically connected to and conducted with the body-side conductive portion 15 of the shield bracket body 10 and the fixing-side conductive portion 21 of the fixing member 20.

### Second Embodiment

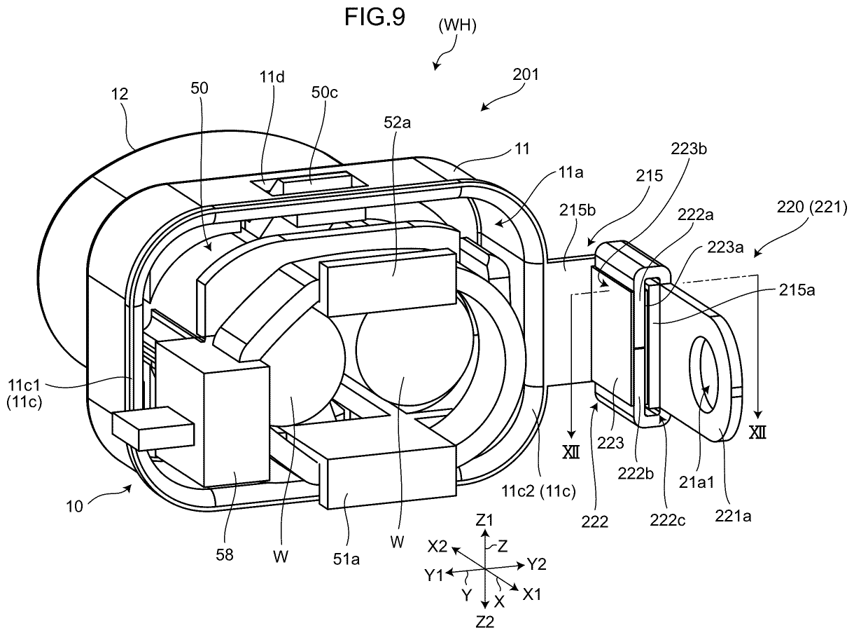

The second embodiment will be described with reference to FIGS. 9 to 12. In a shield bracket 201 according to the present embodiment, in place of the body-side conductive portion 15 and the fixing member 20 in the shield bracket body 10 of the shield bracket 1 of the first embodiment, a substantially plate-shaped body-side conductive portion 215 and a fixing member 220 in which the attachment member 22 is omitted are used. Therefore, the same members and the same portions as those of the first embodiment are denoted by the same reference numerals, and the description thereof will be omitted or simplified. In FIG. 9, the braided member 60 and the object to be fixed 70 are not illustrated.

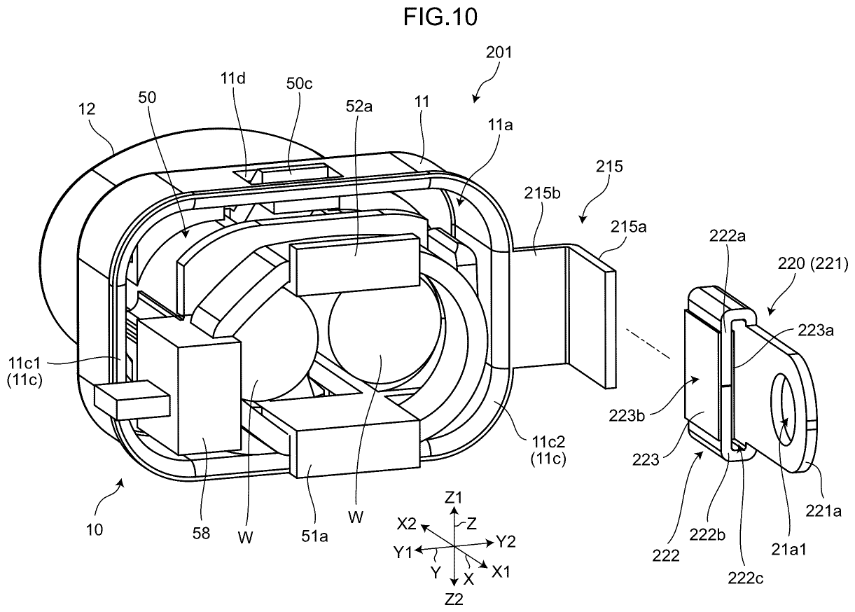

As illustrated in FIGS. 9 and 10, the fixing member 220 of the shield bracket 201 is provided so as to be attached and detached (namely, to be attachable) to the body-side conductive portion 215 of the shield bracket body 10. The body-side conductive portion 215 extends along the other side Y2 in the width direction Y from an edge 11c2 on the other side Y2 in the width direction Y, and is formed in a substantially L shape as viewed from the height direction Z by bending the body-side conductive portion 215 by 90 degrees toward one side X1 in the axial direction X. The edge 11c2 is one of two edges 11c1 and 11c2 which form a part of the edge 11c of the opening 11a in the rectangular tube portion 11 of the shield bracket body 10 and are along the height direction Z. The body-side conductive portion 215 has a plate-like base 215b connected to the shield bracket body 10 and extending along the other side Y2 in the width direction Y, and a body-side contact plate 215a (contact portion) extending from an end of the base 215b on the other side Y2 in the width direction Y to one side X1 in the axial direction X. The base 215b and the body-side contact plate 215a are formed in a plate shape having the same plate width, the base 215b is disposed with the plate surface facing the axial direction X, and the body-side contact plate 215a is disposed with the plate surface facing the width direction Y.

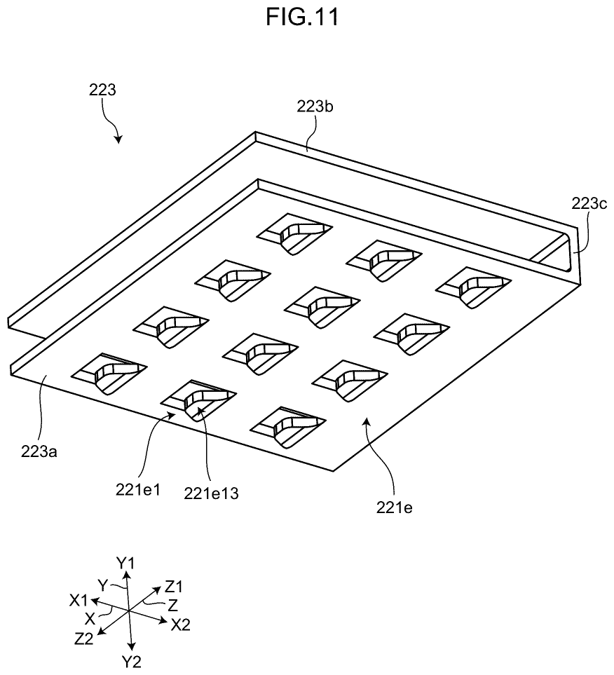

The fixing member 220 is a fixing-side conductive portion 221 including a fixing plate 221a (fixing portion) and a contact member 223 having a spring contact portion 221e (see FIG. 11). That is, the entire fixing member 220 is the fixing-side conductive portion 221. In other words, the fixing member 220 includes the fixing-side conductive portion 221. The fixing plate 221a extends along the axial direction X and is formed in a substantially plate shape with the plate surface facing the width direction Y. The fixing plate 221a has a fixing hole 21a1 on an end side thereof on one side X1 in the axial direction X. The fixing plate 221a includes, on the other side X2 in the axial direction X, an insertion portion 222 having bent plate portions 222a and 222b that are bent so that ends of the plates extending from the fixing plate 221a to one side Z1 and the other side Z2 in the height direction Z abut each other. The insertion portion 222 is formed with an insertion hole 222c that is surrounded by the bent plate portions 222a and 222b and the fixing plate 221a and extends along the axial direction X. The insertion hole 222c is formed to have a width (distance in the height direction Z) and a height (distance in the width direction Y) slightly greater than a width (distance in the height direction Z) and a plate thickness (distance in the width direction Y) of the body-side contact plate 215a, to receive the body-side contact plate 215a which is inserted into the insertion hole 222c.

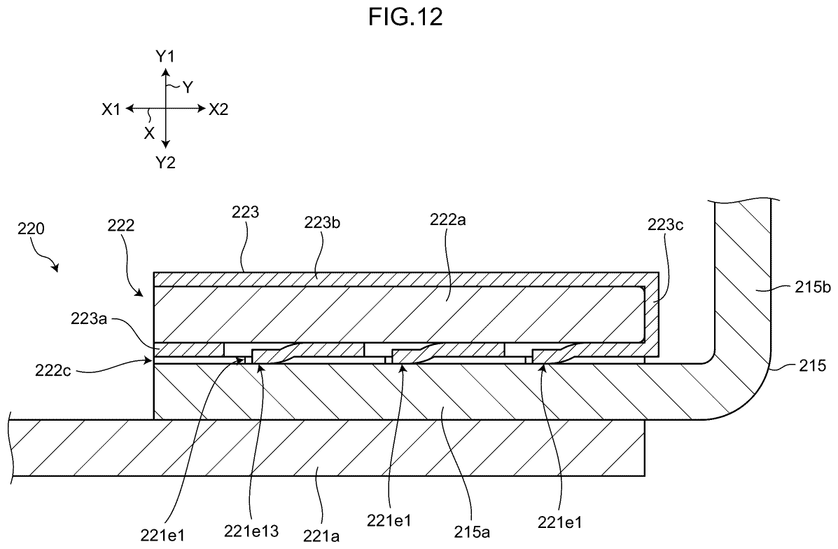

The contact member 223 is made of a sheet metal material having electrical conductivity. As illustrated in FIG. 11, the contact member 223 includes a first plate portion 223a and a second plate portion 223b that are two plates, and a connection plate portion 223c that connects the first plate portion 223a and the second plate portion 223b. The first plate portion 223a and the second plate portion 223b are formed to have a substantially rectangular plate shape and have approximately the same shape. The connection plate portion 223c is provided so as to connect the first plate portion 223a and the second plate portion 223b to each other at ends of the first plate portion 223a and the second plate portion 223b on the other side X2 in the axial direction X. The first plate portion 223a and the second plate portion 223b are separated from each other by a distance substantially equal to the plate thickness of the bent plate portions 222a and 222b in the insertion portion 222 of the fixing member 220 (fixing-side conductive portion 221). The first plate portion 223a is provided with a spring contact portion 221e including a plurality of spring contacts 221e1. As illustrated in FIGS. 11 and 12, each of the spring contacts 221e1 is formed so as to protrude outward (the other side Y2 in the width direction Y) from the first plate portion 223a while connecting the spring contact 221e1 on the other side X2 in the axial direction X to the first plate portion 223a. As a result, the spring contacts 221e1 are supported so that an elastic force is applied. An outer surface of the spring contact 221e1 is a touch surface 221e13. As illustrated in FIG. 12, when the body-side contact plate 215a of the body-side conductive portion 215 is inserted into the insertion hole 222c of the insertion portion 222 of the fixing member 220 from the other side X2 in the axial direction X, the touch surface 221e13 of the spring contact 221e1 is brought into close contact with the plate surface on one side Y1 in the width direction Y of the body-side contact plate 215a due to the elastic force, and the spring contact 221e1 (spring contact portion 221e) and the body-side contact plate 215a are electrically connected. In this manner, the body-side conductive portion 215 and the fixing-side conductive portion 221 are electrically connected and conducted.

In the present embodiment, the shield bracket body 10 is attachable to and detachable from the fixing member 220 fixed to the object to be fixed 70 along the axial direction X. The insertion portion 222 of the fixing member 220 is freely attached to and detachable from the body-side contact plate 215a having a flat plate shape and, thus, the shield bracket body 10 can be easily attached to and detached from the fixing member 220.

### Modification

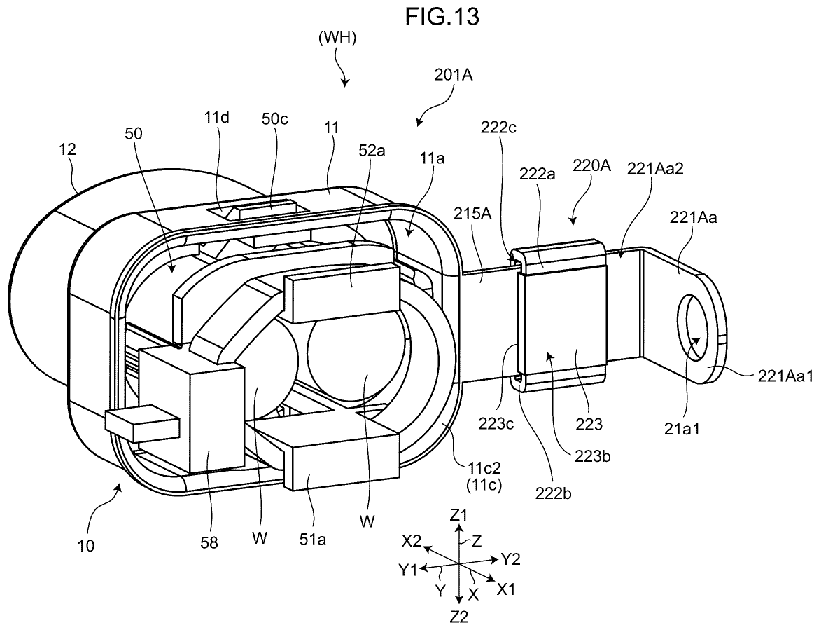

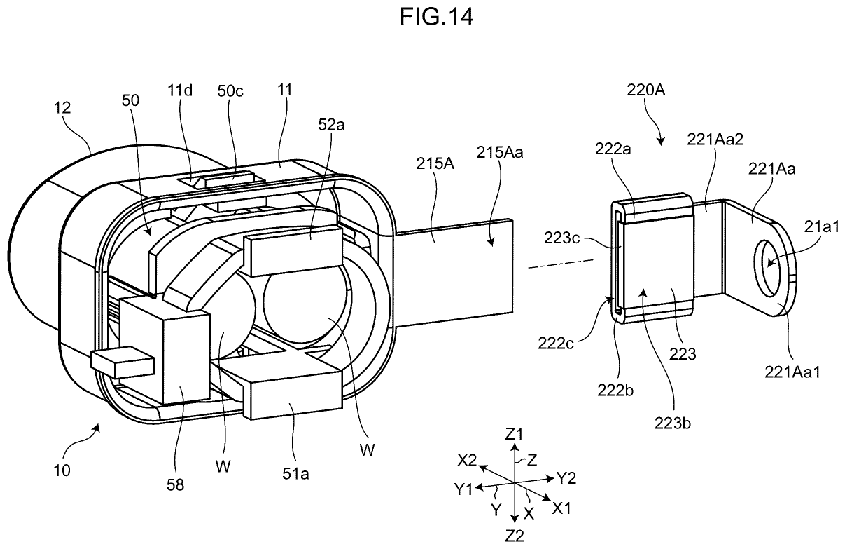

A modification to the second embodiment will be described with reference to FIGS. 13 and 14. In the present modification, in place of the body-side conductive portion 215 and the fixing member 220 (fixing-side conductive portion 221) of the shield bracket 201 of the second embodiment, a body-side conductive portion 215A and a fixing member 220A (fixing-side conductive portion 221A) of a shield bracket 201A in which the mounting direction of the shield bracket body 10 is changed is used. Therefore, the same members and portions as those of the first embodiment and the second embodiment are denoted by the same reference numerals, and the description thereof will be omitted or simplified. In FIG. 13, the braided member 60 and the object to be fixed 70 are not illustrated.

The body-side conductive portion 215A of the present modification is formed in a plate shape extending linearly to the other side Y2 in the width direction Y. The body-side conductive portion 215A is disposed with the plate surface facing the axial direction X. A predetermined range on the distal end side of the body-side conductive portion 215A is set to a body-side contact plate 215Aa (contact portion) that comes into contact with the spring contact portion 221e of the fixing member 220A by inserting the insertion portion 222 of the fixing member 220A. Similarly to the fixing member 220 of the second embodiment, the entire fixing member 220A is a fixing-side conductive portion 221A. A fixing plate 221Aa (fixing portion) of the fixing-side conductive portion 221A in the present modification is formed in a substantially L-shaped plate shape when viewed from the height direction Z. In the fixing plate 221Aa, a distal end portion 221Aa1 provided with a fixing hole 21a1 is disposed with the plate surface facing the width direction Y. On the other hand, a base 221Aa2 provided with the insertion portion 222 is disposed with the plate surface facing the axial direction X.

In the present modification, the shield bracket body 10 is attachable to and detachable from the fixing member 220A fixed to the object to be fixed 70 along the width direction Y. In the present modification, the body-side conductive portion 215A has a linear shape, but can be bent by bending, and the fixing-side conductive portion 221A which is the fixing member 220A can also have a linear shape, and the attachment direction of the shield bracket body 10 to the fixing member 20 and the direction in which the electric wire W is led out can be freely set.

The shield bracket 1, 201, 201A described above includes: the shield bracket body 10 that is formed in a tubular shape so that the electric wire W is inserted therein, and the braided member 60 covering the electric wire W is disposed on an outer periphery thereof, and the shield bracket body 10 is electrically connected to the braided member 60; and the fixing member 20, 220, 220A that is fixed to the object to be fixed 70 and is provided to be attachable to the shield bracket body 10. The wire harness WH includes the electric wire W, the braided member 60 covering the electric wire W, and the shield bracket 1.

As a result, the shield bracket body 10 into which the electric wire W and the braided member 60 are assembled can be attached to the fixing member 20 fixed to the object to be fixed 70 in advance and, thus, workability is improved, the electric wire W and the braided member 60 can be reliably attached to the shield bracket body 10, which makes it possible to provide the shield bracket 1 and the wire harness WH capable of appropriately achieving the fixing of the shield bracket 1 to the object to be fixed 70.

For example, in a case where the wire harness WH is used in a vehicle such as an automobile, in the fixing member 20, GND processing of the braided member 60 may be performed with the body of the vehicle set as the object to be fixed 70. In recent years, due to measures for large current and weight reduction, an aluminum electric wire is sometimes adopted as the electric wire W. In such a case, the size of the electric wire W increases, which sometimes reduces the workability of routing the electric wire W at the time of routing. For example, in the case of using a shield bracket directly fixed to the object to be fixed 70 such as a body, in the work of fixing the shield bracket to which the electric wire W made of an aluminum electric wire or the braided member 60 is attached to the body with a bolt or the like, the reaction force of the electric wire W is large, and thus the reaction force of the electric wire W at the time of fixing the shield bracket to the body is large, which makes it difficult to achieve good attachability.

However, according to the shield bracket 1, 201, 201A and the wire harness WH of the present embodiment, the fixing member 20 is fixed to the body in advance, and the shield bracket body 10 to which the electric wire W and the braided member 60 are attached can be attached to the fixing member 20 by insertion or the like, which significantly improves the attachability. The direction in which the shield bracket body 10 is attached to the fixing member 20, 220, 220A can be freely set, which enables attachment from an appropriate direction according to the layout of the object to be fixed 70 such as a vehicle or the wire harness WH.

In addition, the shield bracket body 10 includes the body-side conductive portion 15, 215, 215A, the fixing member 20, 220, 220A includes the fixing-side conductive portion 21, 221, 221A, and the body-side conductive portion 15, 215, 215A and the fixing-side conductive portion 21, 221, 221A are conducted in a state where the fixing member 20, 220, 220A is attached to the shield bracket body 10. This allows the GND processing of the braided member 60 with good workability to be performed by attaching the braided member 60 to the shield bracket body 10 and fixing the fixing member 20, 220, 220A to the body of the vehicle.

The fixing-side conductive portion 21, 221, 221A includes the fixing plate 21a, 221a, 221Aa made of a sheet metal material and serving as a fixing portion to be fixed to the object to be fixed 70, and the spring contact portion 21e, 221e electrically connected to the body-side contact plate 15a, 215a, 215Aa serving as a contact portion of the body-side conductive portion 15, 215, 215A. This enables the body-side conductive portion 15, 215, 215A to be conducted to the fixing-side conductive portion 21, 221, 221A more reliably.

Further, the fixing member 20 includes the attachment member 22 that is fixed to the fixing-side conductive portion 21 and has the locking portion 22d engaged with the locked opening 15c that is a locked portion of the body-side conductive portion 15. As a result, it is possible to provide the shield bracket 1 in which the body-side conductive portion 15 is prevented from being easily removed and the shield bracket body 10 is prevented from being easily removed from the fixing member 20 while the body-side conductive portion 15 is easily inserted and the work of attaching the shield bracket body 10 to the fixing member 20 is facilitated.

Note that the shield bracket and the wire harness according to the embodiment of the present invention described above are not limited to the embodiment described above, and various modifications can be made thereto within the scope described in the claims.

In the above description, the fixing member is formed to be attachable to and detachable from the shield bracket body. However, for example, another structure can be adopted in which the body-side conductive portion of the shield bracket body cannot be removed from the fixing-side conductive portion of the fixing member after the body-side conductive portion is attached to the fixing-side conductive portion. In the present embodiment, the number of electric wires W is two, but may be one or three or more. Further, in the present embodiment, the shield bracket body and the fixing member are electrically connected to each other via the body-side conductive portion and the fixing-side conductive portion, but the GND processing may be separately provided without electrically connecting the shield bracket body and the fixing member. Further, the body-side conductive portion 15 in the first embodiment is configured such that the locked opening 15c is engaged with the locking protrusion 22d2 of the locking portion 22d, but the present disclosure is not limited thereto, and may have a locking structure including a locked portion and a locking portion of another form.

The shield bracket and the wire harness according to the present embodiment may be configured by appropriately combining the constituent elements of the embodiments and the modification described above.

The shield bracket and the wire harness according to the present embodiment have an effect of appropriately achieving the fixing of the shield bracket to an object to be fixed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A shield bracket comprising:
a shield bracket body that is formed in a tubular shape so that an electric wire is inserted in the shield bracket body, and a braided member is disposed on an outer periphery of the shield bracket body to cover the electric wire, and the shield bracket body is electrically connected to the braided member; and
a fixing member that is fixed to an object to be fixed and is provided to be attachable to the shield bracket body.

2. The shield bracket according to claim 1, wherein the shield bracket body includes a body-side conductive portion, the fixing member includes a fixing-side conductive portion, and the body-side conductive portion and the fixing-side conductive portion are conducted in a state where the fixing member is attached to the shield bracket body.

3. The shield bracket according to claim 2, wherein the fixing-side conductive portion is made of a sheet metal material, and includes a fixing portion fixed to the object to be fixed and a spring contact portion electrically connected to a contact portion of the body-side conductive portion.

4. The shield bracket according to claim 2, wherein the fixing member includes an attachment member that is fixed to the fixing-side conductive portion and has a locking portion to be engaged with a locked portion of the body-side conductive portion.

5. The shield bracket according to claim 3, wherein the fixing member includes an attachment member that is fixed to the fixing-side conductive portion and has a locking portion to be engaged with a locked portion of the body-side conductive portion.

6. A wire harness comprising:
an electric wire;
a braided member that covers the electric wire; and
a shield bracket that includes a shield bracket body that is formed in a tubular shape so that an electric wire is inserted in the shield bracket body, and the braided member is disposed on an outer periphery of the shield bracket body, and the shield bracket body is electrically connected to the braided member, and a fixing member that is fixed to an object to be fixed and is provided to be attachable to the shield bracket body.
